(19) United States
(12) Patent Application Publication
(10) Pub. No.: US 2002/0135694 A1
(43) Pub. Date: Sep. 26, 2002

(54) Dental video camera

(76) Inventor: Ronald R. Williams, Camino, CA (US)

Correspondence Address: W. Edward Johansen, 11661 San Vicente Boulevard, Los Angeles, CA, 90049, US

(21) Appl. No.: 10/059,077

(22) Filed: Jan. 28, 2002

Related U.S. Application Data
(63) Continuation-in-part of application No. 08/969,107, filed on Nov. 13, 1997.
Application No. 08/969,107 is a continuation-in-part of application No. 08/816,447, filed on Mar. 12, 1997, now abandoned.
Application No. 08/816,447 is a continuation-in-part of application No. 08/560,397, filed on Nov. 17, 1995, now Pat. No. 5,771,067.
Application No. 08/560,397 is a continuation-in-part of application No. 08/426,119, filed on Apr. 20, 1995, now Pat. No. 5,737,013.
Application No. 08/426,119 is a continuation-in-part of application No. 08/303,019, filed on Sep. 8, 1994, now Pat. No. 5,523,782.
Application No. 08/303,019 is a continuation-in-part of application No. 07/943,716, filed on Sep. 11, 1992, now abandoned.

(51) Int. Cl. H04N 5/225; H04N 7/18; H04N 5/222

(52) U.S. Cl. 348/375; 348/77; 348/370; 348/340

(57) ABSTRACT

A dental video camera includes a housing and a charge coupled device, a plurality of lamps and a focusing lens system. The charge-coupled device is disposed within and slidably coupled to the elongated cavity of the housing at said proximal end thereof. The lamps are optically coupled to the charge-coupled device. A mechanism bi-directionally drives the charge-coupled device laterally to produce back and forth lateral movements.

This is a continuation-in-part of the application filed on Nov. 13, 1997 under Ser. No. 08/969,107, which is a continuation-in-part of the application filed on Mar. 12, 1997 under Ser. No. 08/816,447, which is a continuation-in-part of the application filed on Nov. 827, 1995 under Ser. No. 08/560,397, now U.S. Pat. No. 5,771,067, which is a continuation-in-part of the application filed on Apr. 20, 1995 under Ser. No. 08/426,119, now U.S. Pat. No. 5,737,013, which is a continuation-in-part of the application filed on Sep. 8, 1994 under Ser. No. 08/303,019, now U.S. Pat. No. 5,523,782, which is a continuation-in-part of the application filed on Sep. 11, 1992 under Ser. No. 07/943,716.

### BACKGROUND OF THE INVENTION

The field of the invention is dental video cameras.

U.S. Pat. No. 6,190,309 teaches a video scope that has an entry section that can advance into an object; and a grip section which is disposed at the back of the entry section and to be held by an operator. The video scope includes a light-reflecting body, an objective-lens, a solid-state image-pickup device, a light source, a window of incidence for image pickup rays and illumination windows that are located in the vicinities of the window of incidence. A power source is disposed in the grip section for driving the light source. A portable accommodation case has an accommodation space for accommodating the video scope. A lid has a thin display attached thereto and can rotate freely and stop at an optional position. The thin display is capable of displaying an image that is picked up by the video scope.

U.S. Pat. No. 5,908,294 teaches a hand-held dental video camera which includes a window for receiving light. In some aspects of the invention, a lamp is mounted distally beyond the window and aimed to illuminate a subject. A white light emitting diode is used to illuminate the subject.

U.S. Pat. No. 5,523,782 teaches a video dental camera that includes a light source, a charge coupled device and an adjustable focus lens system. Other examples of existing system can be found in U.S. Pat. Nos. 4,575,805 and 5,527,261. Until now, however, it has been extremely difficult to fashion a sufficiently slim instrument. Slim instruments are desirable because they provide accessibility to places that thicker instruments cannot reach. Moreover, even in cases where a thick instrument can provide adequate access, the slimmer instruments can reduce the discomfort experienced by the patient. One factor contributing to the thickness of previous dental video cameras is the type of light source that is incorporated into the camera head.

U.S. Pat. No. 5,429,502 teaches a dental camera that uses an external light source and route the light from the source to the head using fiber optics. In this arrangement the optical fibers travel through the cable and through the body of the handheld camera unit thereby resulting in a stiffer cable reducing maneuverability and a thicker handheld unit. The fiber optic connections require a complex and expensive connector as compared to fully electrical connectors. Using fiber optics to illuminate the subject requires increased power because some of the light energy is lost in the optical fiber.

There are imaging devices that use lamps at the end of the imaging head instead of fiber optics. These lamps have not been used in configurations that minimize the thickness of the instrument. The lamps in the dental camera of U.S. Pat. No. 5,523,782 are positioned axially away from the imaging window. The lamp in the dental camera of U.S. Pat. No. 4,575,805 is positioned on the proximal side of the imaging window. Both of these configurations result in relatively thick instruments. In addition, the lamps used in previous imaging devices had significant shortcomings. A halogen lamp that is used in the dental camera of U.S. Pat. No. 5,527,261 consumes significant power and generates heat. The lighting emitting device that are used The lamp in the dental camera of U.S. Pat. No. 4,575,805, like all ordinary light emitting diodes, produces essentially monochromatic light that can make diagnosis of certain medical conditions difficult.

U.S. Pat. No. 5,124,797 teaches a video-imaging camera that has a detachable distal module that is replaceable with one of different characteristics and sterilizable. A non-replaceable charge coupled device and a video transmitter are connected to an inner body that includes a lens tube. The module includes an outer body encasing the inner body. The inner body may have a filter at its tip and a magnifying lens optically connected to an image conduit optical segment. The inner body receives an image conduit. The lens focuses the output of the image conduit and is disposed in the inner body on a charge coupled device microprocessor. The model may be replaced with an angular distal end or lenses of different fields of view. Fiber optic light filaments may be used to illuminate the field of view of the tip of the module, either housed internally or externally of the inner body.

U.S. Pat. No. 4,300,167 teaches an automatic iris control system that is connected between a video camera and optical input device that produces an optical image from a light directed upon and reflected from a subject. The optical image is directed onto the surface of an electronic imaging tube in the video camera. The optical image has a wide variation of reflected light due to variations in distance of the subject from the light source. The automatic iris control system has an adjustable iris and a drive motor. The drive motor is located between the surface of the electronic imaging tube. An optical input device dynamically varies the intensity of the optical image applied to the electronic imaging tube of the video camera. A light intensity programming circuit establishes a desired light intensity level on the surface of the electronic imaging tube of the video camera and an automatic iris control circuit. The automatic iris control circuit has a low gain amplifier, a weighted peak response detector, a comparator and a circuit. The circuit controls the current to the iris drive motor and a circuit for providing a feedback signal representing the direction in which the iris must be adjusted by the motor to control the light intensity on the surface of the electronic imaging tube of the video camera is shown.

U.S. Pat. No. 5,047,847 teaches a liquid crystal assembly. The assembly forms at least a part of an image optical system. The assembly includes a plurality of liquid crystals. The liquid crystal have a refractive index anisotropy and different response frequencies of molecule orientation so that the transitivity and refractive index of the plurality of liquid crystals may be independently controlled with few signal lines by varying the frequency of the driving signal applied to the liquid crystal assembly.

U.S. Pat. No. 5,296,944 teaches an image scanner. The image scanner includes a light source that illuminates an original document, an image sensor that receives a reflected light from the original document and converts the same into an output signal of image data, a device that relatively moves the original document and the image sensor, an iris mechanism that is provided on an optical path between the original document and the image sensor, a reference reflection plane that is provided such that a light from the light source is reflected and the reflection light becomes incident on the image sensor, a comparing circuit that compares a level of an output signal from the image sensor with a reference level when the image sensor receives the light from the reference reflection plane and a device for correcting a dynamic range of the image scanner by controlling the iris mechanism on the basis of the compared output.

U.S. Pat. No. 5,124,797 teaches a dental video camera. The dental video camera includes a proximal housing and a distal module consists of a body containing a magnifying lens, a filter and an optical fiber image conduit. The distal module is sterilizable. The proximal housing that is unable to withstand autoclaving does not require sterilization since it does not contact the patient.

U.S. Pat. No. 4,919,114 teaches an endoscope that includes a solid state imaging device and a flexible insertable part for insertion into a body cavity. The solid-state imaging device obtains an optical image of an observed part through an observing window provided in a tip part of the flexible insertable part.

U.S. Pat. No. 4,858,001 teaches a hand held endoscope that consists of a body, a camera and a removable and interchangeable objective element which is capable of presenting an image of an object to the camera. An optically transparent sheath is capable of isolating the endoscope from the working environment.

U.S. Pat. No. 4,727,416 teaches a video dental camera which includes a handle, a camera head and a mirror. The camera head is located at the distal end of the handle with the camera head being disposed at an angle to the handle.

U.S. Pat. No. 4,757,381 teaches sheaths which are dispensed on a perforated role. Each sheath prevents a dental camera from coming into contact with the patient, while allowing the dental camera to function properly.

U.S. Pat. No. 4,914,521 teaches a sterilizable video camera cover. The cover has a connector and a receptacle. The connector has a guide-way for receiving a video camera within a predetermined fixed orientation and serves as a bacteria barrier. The receptacle holds the video camera against a window at the distal end of the connector.

U.S. Pat. No. 4,915,626 teaches a dental video camera which is used to view an image of the interior of the mouth of a patient. The dental video camera displays contemporaneously a video image of the interior of the mouth.

U.S. Pat. No. 4,589,404 teaches a laser endoscope that includes a video camera and an optical system. The video camera transmits an image through the optical system.

U.S. Pat. Nos. 4,600,939 and 4,639,772 teach a highly compact focusable video camera that includes an optical system, a sensor-converter and a video electronic processing circuit. The sensor-converter receives an optical image passing through the optical system and converts the optical image to an unprocessed video signal. The video electronic processing circuit processes the unprocessed video signal.

U.S. Pat. No. 4,837,615 teaches a hand held optical probe. The probe includes a light source, two bundles of optical fibers for directing light axially into a fastener hole. The tip end of each bundle is directed at a right angle to the axis of the fastener hole so that the panel edges are illuminated.

U.S. Pat. No. 5,604,531 teaches an in vivo video camera system that includes a swallowable capsule, a transmitter, a light emitting diode and a reception system. The swallowable capsule includes a camera system and an optical system for imaging an area of interest onto the camera system. The transmitter transmits the video output of the camera system and the reception system receives the transmitted video output.

U.S. Pat. No. 5,527,261 teaches a hand-held, fully remote diagnostic instrument having video capability that is configured for any one of a number of clinical or industrial applications. The instrument has a casing that includes a hand-held body portion, a neck portion that extends from the body portion to a head portion that is formed of a back cover, a front cover, and a sealing gasket to form a fully soakable instrument. A circuit board assembly in the body portion contains video processing circuitry and a flexible neck board. The neck board extends forward from the body portion through the neck portion of the casing to a headboard located in the head portion of the casing. A solid-state imager and a miniature lamp are disposed on the headboard. The front cover contains an adjustable focus lens cell for focusing on the imager an image of a target in the field of view of the lens cell. The instrument can be configured for various applications by installing front and back covers that are suited for a specific purpose. The instrument can thus be used as a dental camera. The instrument provides a monitor-ready, standard format, full color video signal to a remotely located monitor.

U.S. Pat. No. 6,019,721 teaches a focus mechanism that has an actuator that is positioned near the rear of a handheld piece. The focus mechanism allows a lens element to be moved with respect to a stationary image sensor to achieve a range of focus. When implemented as a manual focusing feature of an intra-oral dental camera the focus mechanism allows greater control of focus as the user's hand that grasps the actuator. A variable profile cam allows high precision focus with the camera inside the patient's mouth, while still allowing enough focus travel for capturing a head shot or an image of the patient's smile or face when the camera is moved outside the patient's mouth. The camera includes a body, an image sensor and a lens element. The body has a proximal end, a distal end and a cavity. The distal end has an opening for light to enter the cavity. The body has a lens portion with a slot therein. The image sensor is mounted in a fixed position inside the cavity. The lens element is moved to change the field of focus.

Intra-oral cameras are used for capturing images of the inside of a patient's mouth. The camera has an elongated body that contains an image sensor and optics. The optics and the sensor are designed for capturing images of the inside of the mouth when the distal end of the camera is inserted into the patient's mouth. Wires carrying electronic signals connect the image sensor to the proximal end of the camera where a communication interface is provided to an image processing system or monitor that allows manipulation and display of the images. Several types of focus mechanisms for the intra-oral camera have been developed. One type has a rotatable dial located at approximately half-way between the proximal and distal ends. Focusing is accomplished by rotating the dial that translates into linear motion of a focusing lens with respect to a stationary image sensor. The focusing lens is positioned between the image sensor and optical elements near the distal end. Locating the dial in the middle of the camera, however, places the user's hand too close to the patient's mouth when focusing. An alternative technique for an intra-oral camera places the focus dial farther away from the distal end, at the proximal end of the camera. In that case, rotation of the dial moves the image sensor relative to the optics to achieve focus. Although in that case the dial is conveniently located far from the distal end of the camera that is inserted into the patient's mouth, long term use by repeated focusing might result in the failure of the wire connection between the image sensor and the proximal end of the camera.

The applicant hereby incorporates the above referenced patents into his application.

### SUMMARY OF INVENTION

The present invention is generally directed to a dental video camera. The dental video camera includes housing, a focusing lens and a charge coupled device camera system. The focusing lens and the charge coupled device camera system are disposed in the housing.

In a first aspect of the present invention, the dental video camera includes a mechanism for adjusting the charge coupled device camera system between a near field of focus and a far field of focus.

In a second aspect of the present invention, the dental video camera includes a light source that is disposed at the distal end of the elongated cavity of the housing.

In a third aspect of the present invention, the light source is at least one lamp that provides direct illumination.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### BRIEF DESCRIPTION OF THE DRAWINGS

FIG. 1 is a perspective view of a dental video camera.

FIG. 2 is a side elevation in cross-section of a fragmented distal portion or the dental video camera of FIG. 1 taken along the line 2-2 or FIG. 4.

FIG. 3 is a side elevation in cross-section of the proximal portion of the dental video camera of FIG. 1 taken along the line 3-3 of FIG. 4.

FIG. 4 is a top plan view in cross-section of the fragmented distal portion of the dental video camera of FIG. 1 taken along the line 4-4 of FIG. 2.

FIG. 5 is a cross-sectional view of the fragmented distal portion of the dental video camera of FIG. 1 taken along the line 5-5 of FIG. 4.

FIG. 6 is a cross-sectional view of the dental video camera of FIG. 1 taken along the line 6-6 of FIG. 2.

FIG. 7 is a cross-sectional view of the dental video camera of FIG. 1 taken along the line 7-7 of FIG. 2.

FIG. 8 is a cross-sectional view of the dental video camera of FIG. 1 taken along the line 8-8 of FIG. 3.

FIG. 9 is a cross-sectional view of a remote control transmitter for use with the dental video camera of FIG. 1 taken along line 9-9 of FIG. 10.

FIG. 10 is a cross-sectional view of the remote control transmitter of FIG. 9.

FIG. 11 is a side elevation in cross-section of a fragmented distal portion of a dental video.

FIG. 12 is a cross-sectional view of the dental video camera of FIG. 11 taken along the line 12-12 of FIG. 11.

FIG. 13 is a side elevation in cross-section of a fragmented distal portion of a dental video camera.

FIG. 14 is a cross-sectional view of the dental video camera of FIG. 13 taken along the line 14-14 of FIG. 13.

FIG. 15 is a cross-sectional view of the dental video camera of FIG. 13 taken along the line 15-15 of FIG. 13.

FIG. 16 is a side elevation in cross-section of a fragmented distal portion of a dental video camera.

FIG. 17 is a block diagram of an in vivo video camera system that is constructed and operative in accordance with U.S. Pat. No. 5,604,531.

FIG. 18 is a schematic diagram of a video camera capsule forming part of the in vivo video camera system of FIG. 17.

FIG. 19 is a side elevation in cross-section of an optical system within the distal portion of a dental video camera with an adjustable iris.

FIG. 20 is a transverse view in cross-section of of the distal portion of the dental video camera with the adjustable iris of FIG. 19 when the knob has been rotated clockwise forty-five degrees from the neutral position.

FIG. 21 is a side elevation in cross-section of the mechanical system of the distal portion of the dental video camera with the adjustable iris of FIG. 19 taken along line 21-21 of FIG. 20.

### DESCRIPTION OF THE PREFERRED EMBODIMENTS

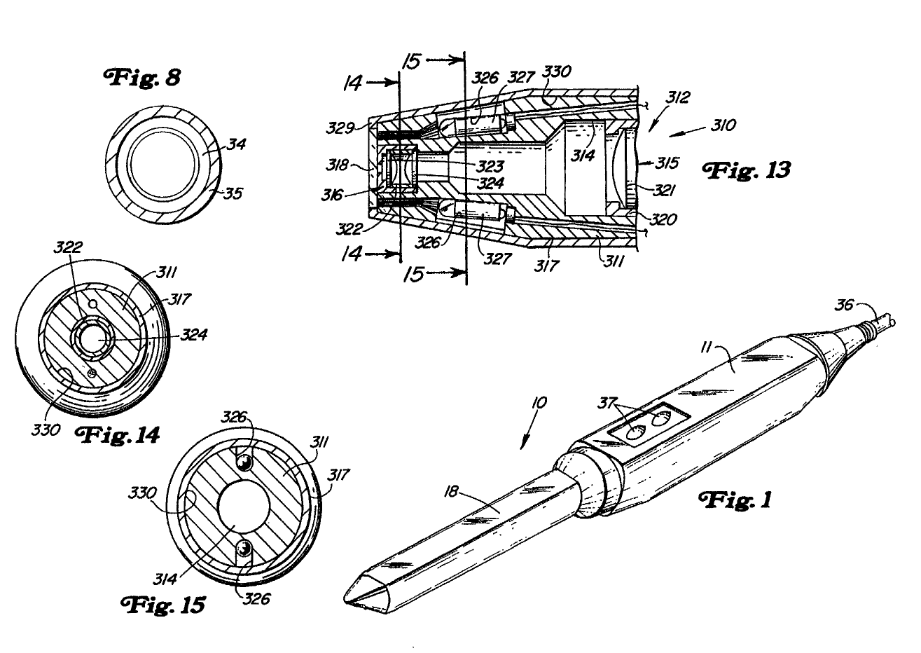

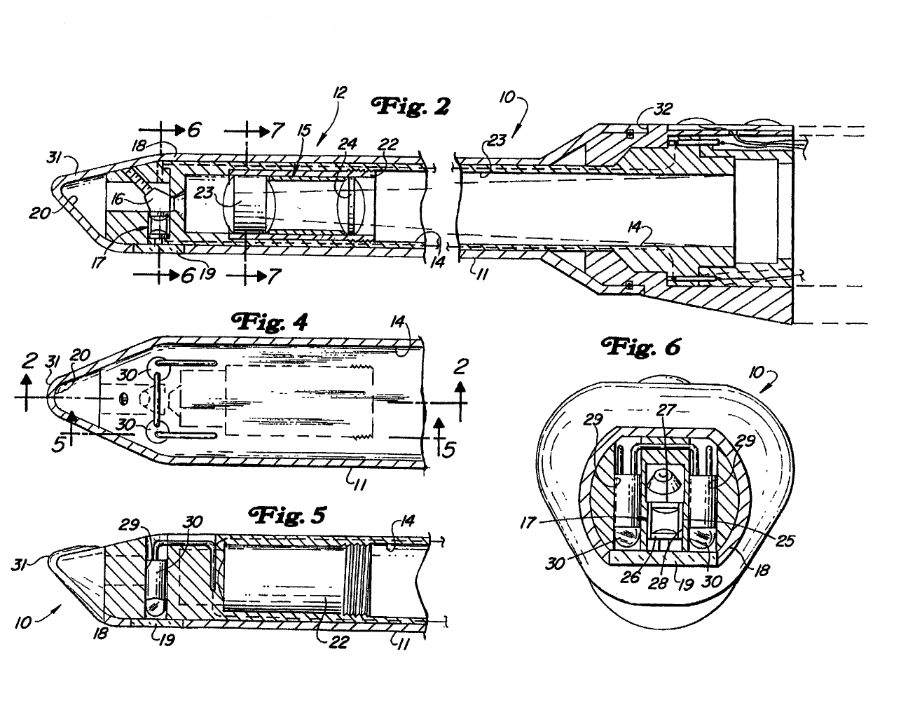

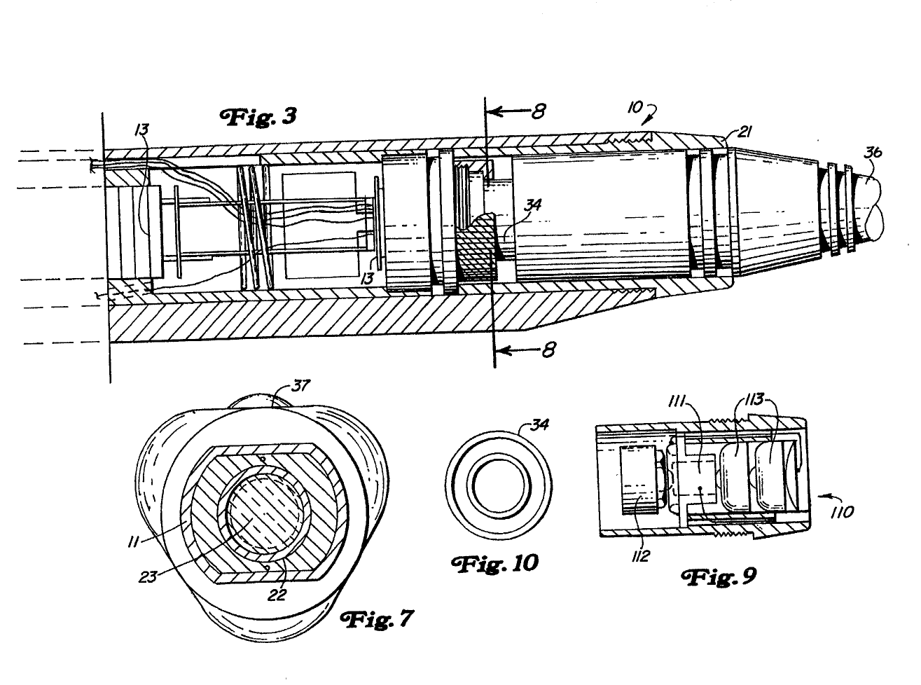

Referring to FIG. 1 in conjunction with FIG. 2 and FIG. 3 a dental video camera 10 includes housing 11, an optical system 12 and a charge coupled device camera 13. The housing 11 has an elongated cavity 14 that has a distal portion and a proximal portion. The optical system 12 is disposed in the distal portion of the elongated cavity 14 of the housing 11. The charge coupled device camera 13 is disposed in the proximal portion of the elongated cavity 14 of the housing 11. The optical system 12 includes an adjustably focusing lens system 15, a penta-prism 16, a fixed focusing lens system 17 and a sheath 18 which has an optical window 19. The housing 11 has a distal end 20 and a proximal end 21. The penta-prism 16 may be replaced with another optical element that can deflect, deviate, invert or rotate an image. The adjustably focusing lens system 15 includes a first sleeve 22, a first achromatic lens 23 and a second achromatic lens 24. The adjustably focusing lens system 15 may include only a single achromatic lens. A singlet lens, a doublet lens or triplet lens may replace the first achromatic lens 23. The first and second achromatic lenses 23 and 24 are disposed in the first sleeve 22 and are optically coupled to the charge coupled device camera 13. The adjustably focusing lens system 15 is disposed within the elongated cavity 14 of the housing 11 at the distal end 20.

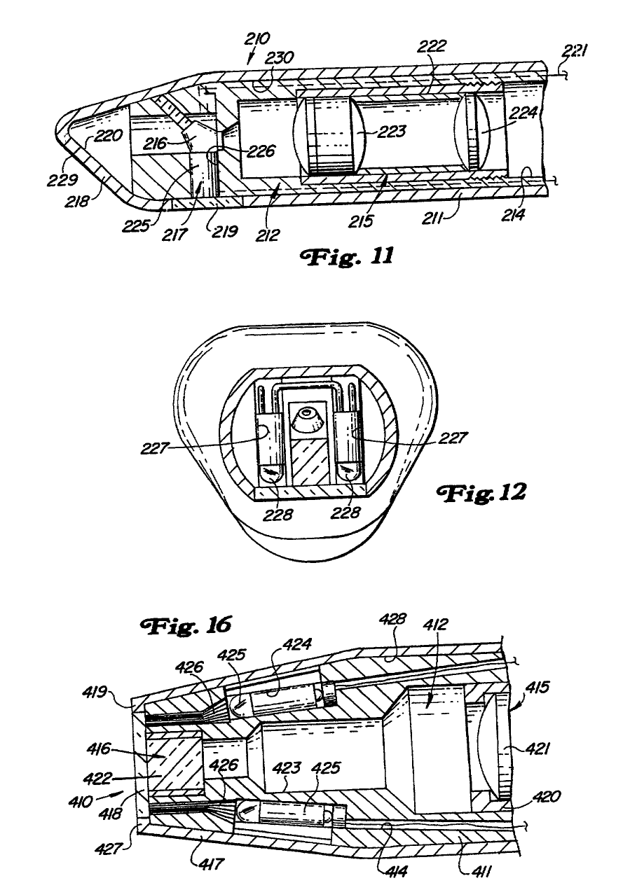

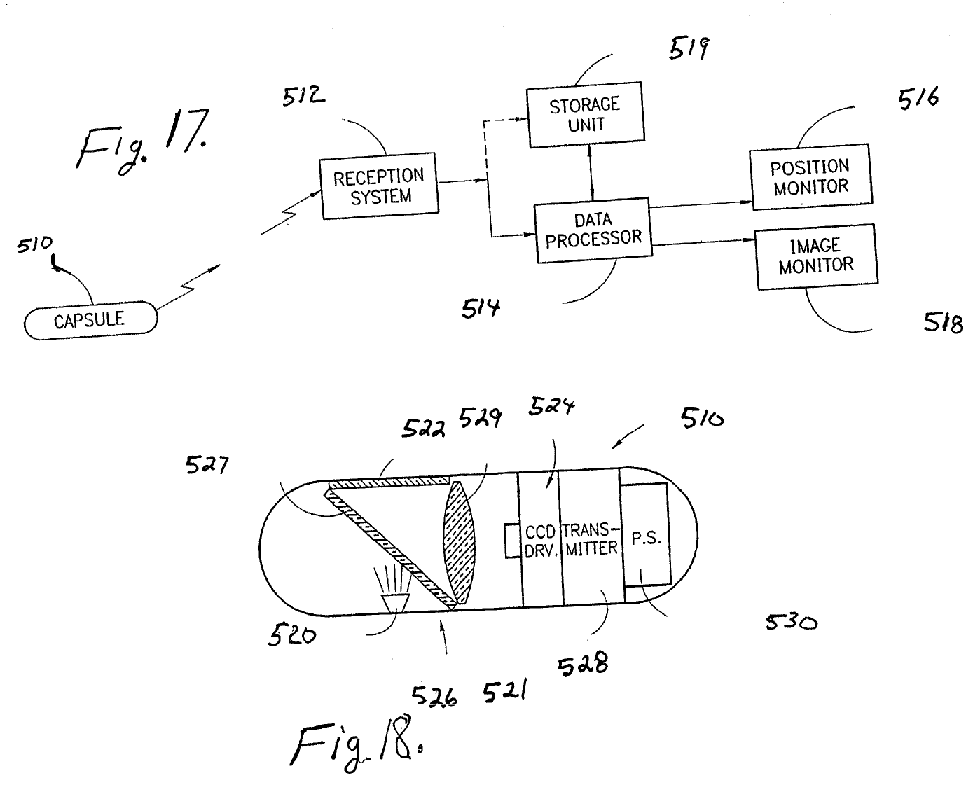

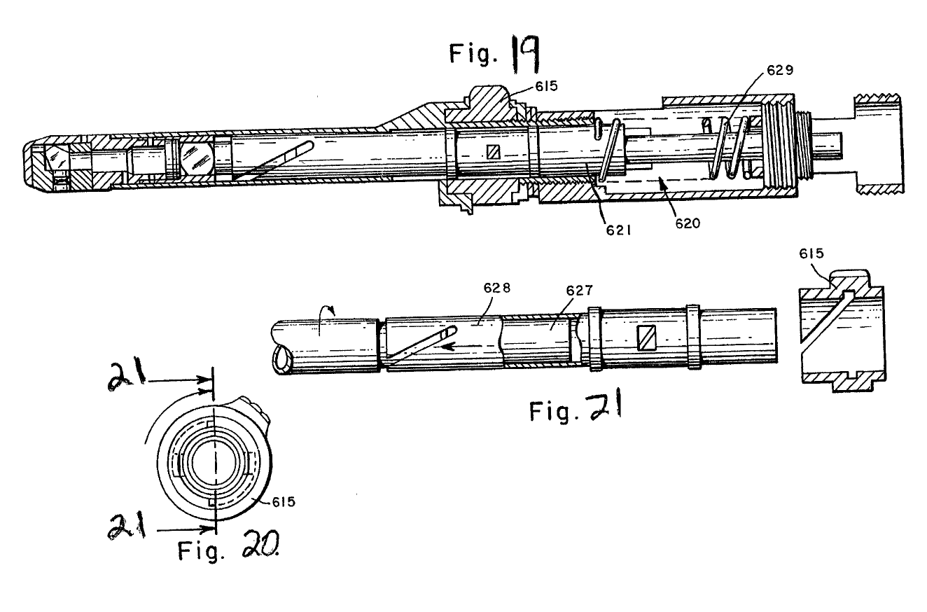

Referring to FIG. 4 in conjunction with FIG. 5 and FIG. 6 the fixed focusing lens system 17 includes a second sleeve 25, a first micro-lens 26 and a second micro-lens 27. The first and second micro-lenses 26 and 27 are disposed in the second sleeve 25. The penta-prism 16 optically couples the fixed focusing lens system 17 to the adjustably focusing lens system 15. The elongated cavity 14 of the housing 11 has a bore 28 that is orthogonally disposed thereto at the distal end 20 thereof. The fixed focusing lens system 17 is disposed within the bore 28. The housing 11 further has two parallel orthogonally disposed cavities 29 at its distal end 20. The internal surfaces of two parallelly disposed cavities 29 are either polished or plated. They act as reflectors in order to direct heat toward the optical window 19 of the sheath 18 in order to defog the optical window 19 and minimize heat build-up within housing 11 at the distal end 20. The dental video camera 10 also includes two lamps 30 that are disposed in the two inwardly angled, orthogonally disposed cavities 29 of the housing 11. The housing 11 dissipates heat from the two lamps 30 that provide both direct illumination and anti-fogging control through the optical window 19 of the sheath 18. The sheath 18 has a distal end 31, a proximal end 32 and an elongated cavity 33. The housing 11 is removably inserted into the elongated cavity 33 of the sheath 18.

Referring to FIG. 2 in conjunction with FIG. 3 and FIG. 7 the adjustably focusing lens system 15 is optically coupled to the charge coupled device camera 13. The penta-prism 16 optically couples the fixed focusing lens system 17 to the adjustably focusing lens system 15. The optical window 19 of the sheath 18 is optically aligned and optically coupled to the fixed focusing lens system 17.

Referring to FIG. 3 in conjunction with FIG. 8 the dental video camera 10 further includes a multiple-pin male connector 34, a multiple-pin female connector 35, a cable 36 and external switches 37. The multiple-pin male connector 34 is electrically coupled to the multiple-pin female connector 35. The multiple-pin female connector 35 is electrically coupled to the cable 36. The cable 36 has a plurality of wires which connect the external switches 37 to a video processor, a recording device and a thermal printer to the charge coupled device camera 13 and the two lamps 30 to a power source.

Referring to FIG. 9 in conjunction with FIG. 3 and FIG. 10 a dental video camera 110 includes a remote control transmitter 111. The remote control transmitter 111 has a multiple-pin female connector 112 and two batteries 113. The batteries 113 are either rechargeable or replaceable and are a source of power to the two lamps 30. The multiple-pin male connector 34 is electrically coupled to the multiple-pin female connector 112 of the remote control transmitter 111. A receiver remotely couples the thermal printer, the video processor and the recording device to the remote control transmitter 111 so that one of the external switches 37 controls each of the thermal printer, the video processor and the recording device.

Referring to FIG. 11 in conjunction with FIG. 12 a dental video camera 210 includes housing 211, an optical system 212 and a charge coupled device camera. The housing 211 has an elongated cavity 214 that has a distal portion and a proximal portion. The optical system 212 is disposed in the distal portion of the elongated cavity 214 of the housing 211. The charge coupled device camera is disposed in the proximal portion of the elongated cavity 214 of the housing 211. The optical system 212 includes a adjustably focusing lens system 215, a penta-prism 216, a fixed focusing lens system 217 and a sheath 218 which has an optical window 219. The housing 211 has a distal end 220 and a proximal end 221. The adjustably focusing lens system 215 includes a first sleeve 222, a first achromatic lens 223 and a second achromatic lens 224. A singlet lens, a doublet lens or a triplet lens may replace the first achromatic lens 223. The first and second achromatic lenses 223 and 224 are disposed in the first sleeve 222 and are optically coupled to the charge coupled device camera. The adjustably focusing lens system 215 is disposed within the elongated cavity 214 of the housing 211 at the distal end 220. The penta-prism 216 may be replaced with another optical element that can deflect, deviate, invert or rotate an image. The fixed focusing lens system 217 includes a gradient-indexed lens 225. The penta-prism 216 optically couples the fixed focusing lens system 217 to the adjustably focusing lens system 215. The elongated cavity 214 of the housing 211 has a bore 226 that is orthogonally disposed thereto at the distal end 220 thereof. The fixed focusing lens system 217 is disposed within the bore 226. The housing 211 has two parallelly disposed cavities 227 at its distal end 220. The dental video camera 210 also includes two lamps 228 that are disposed in the two parallelly disposed cavities 229 of the housing 211. The two lamps 228 provide direct illumination through the optical window 219 of the sheath 218. The sheath 218 has a distal end 229, a proximal end and an elongated cavity 230. The housing 211 is removably inserted into the elongated cavity 230 of the sheath 218. The adjustably focusing lens system 215 is optically coupled to the charge coupled device camera. The penta-prism 216 optically couples the fixed focusing lens system 217 to the adjustably focusing lens system 215. The optical window 219 of the sheath 218 is optically aligned and optically coupled to the fixed focusing lens system 217.

Referring to FIG. 13 in conjunction with FIG. 14 and FIG. 15 a dental video camera 310 includes housing 311, an optical system 312 and a charge coupled device camera. The housing 311 has an elongated cavity 314 that has a distal portion and a proximal portion. The optical system 312 is disposed in the distal portion of the elongated cavity 314 of the-housing 311. The charge coupled device camera is disposed in the proximal portion of the elongated cavity 314 of the housing 311. The optical system 312 includes an adjustably focusing lens system 315, a fixed focusing lens system 316 and a sheath 317 which has an optical window 318. The housing 311 has a distal end 319 and a proximal end. The adjustably focusing lens system 315 includes a first sleeve 320, a first achromatic lens and a second achromatic lens 321. A singlet lens, a doublet lens or a triplet lens may replace the first achromatic lens. The first and second achromatic lenses 321 are disposed in the first sleeve 320 and are optically coupled to the charge coupled device camera. The adjustably focusing lens system 315 is disposed within the elongated cavity 314 of the housing 311 at the distal end 319. The fixed focusing lens system 316 includes a second sleeve 322, a first micro-lens 323 and a second micro-lens 324. The first and second micro-lenses 323 and 324 are disposed in the second sleeve 322. The fixed focusing a lens system 316 is optically coupled to the adjustably focusing lens system 315. The elongated cavity 314 of the housing 311 has a bore 325 that is axially aligned therewith at the distal end 319 thereof. The fixed focusing lens system 316 is disposed within the bore 325. The housing 311 has two parallel cavities 326 disposed at its distal end 319. The dental video camera 310 also includes two lamps 327 and two bundles 328 of optical fibers. Both bundles 328 of optical fibers are disposed in the two parallel cavities 326 of the housing 311. The two lamps 327 provide light to both of the bundles 328 of optical fibers that provide direct illumination through the optical window 318 of the sheath 317. The sheath 317 has a distal end 329, a proximal end and an elongated cavity 330. The housing 311 is removably inserted into the elongated cavity 330 of the sheath 317. The adjustably focusing lens system 315 is optically coupled to the charge coupled device camera. The fixed focusing lens system 316 is optically coupled to the adjustably focusing lens system 315. The optical window 318 of the sheath 317 is optically aligned and optically coupled to the fixed focusing lens system 316.

Referring to FIG. 16 a dental video camera 410 includes housing 411, an optical system 412 and a charge coupled device camera. The housing 411 has an elongated cavity 414 that has a distal portion and a proximal portion. The optical system 412 is disposed in the distal portion of the elongated cavity 414 of the housing 411. The charge coupled device camera is disposed in the proximal portion of the elongated cavity 414 of the housing 411. The optical system 412 includes an adjustably focusing lens system 415, a fixed focusing lens system 416 and a sheath 417 that has an optical window 418. The housing 411 has a distal end 419 and a proximal end. The adjustably focusing lens system 415 includes a first sleeve 420, a first achromatic lens and a second achromatic lens 421. A singlet lens, a doublet lens or a triplet lens may replace the first achromatic lens. The first and second achromatic lenses 421 are disposed in the first sleeve 420 and are optically coupled to the charge coupled device camera. The adjustably focusing lens system 415 is disposed within the elongated cavity 414 of the housing 411 at the distal end 419. The fixed focusing lens system 416 includes a gradient-indexed lens 422. The fixed focusing lens system 416 is optically coupled to the adjustably focusing lens system 415. The elongated cavity 414 of the housing 411 has a bore 423 that is axially aligned therewith at the distal end 419 thereof. The fixed focusing lens system 416 is disposed within the bore 423. The housing 411 has two parallel cavities 424 disposed at its distal end 419. The dental video camera 410 includes two lamps 425 and two bundles 426 of optical fibers both of those are disposed in the two parallel cavities 424 of the housing 411. The two lamps 425 provide light to the bundles 426 of optical fibers that provide direct illumination through the optical window 418 of the sheath 417. The sheath 417 has a distal end 427, a proximal end and an elongated cavity 428. The housing 411 is removably inserted into the elongated cavity 428 of the sheath 417. The adjustably focusing lens system 415 is optically coupled to the charge coupled device camera. The fixed focusing lens system 416 is optically coupled to the adjustably focusing lens system 415. The optical window 418 of the sheath 417 is optically aligned and optically coupled to the fixed focusing lens system 416.

Referring to FIG. 17 an in vivo video camera system includes a swallowable capsule 510 for viewing inside the digestive system and for transmitting at least video data, a reception system 512 located outside a patient and a data processor 514 for processing the video data. The data processor 514 operates two monitors, a position monitor 516 on which the current location of the capsule 510 within the digestive system is displayed and an image monitor 518 on which the image currently viewed by the capsule 510 is displayed. The reception system 512 can either be portable, in which case, the data it receives is temporarily stored in a storage unit 519 prior to its processing in data processor 514, or it can be stationary and close to the data processor 514.

Referring to FIG. 18 in conjunction with FIG. 17 the capsule 510 includes a light source 520, a viewing window 522, a camera system 524, an optical system 526, a transmitter 528 and a power source 530. The light source 520 illuminates the inner portions of the digestive system through the camera system 524. The camera system 524 may be a charge-coupled device (charge coupled device) camera and detects the images. The optical system 526 focuses the images onto the charge coupled device camera system 524. The transmitter 528 transmits the video signal of the charge coupled device camera system 524. The power source 530 may be a battery and provides power to the entirety of electrical elements of the capsule 510. The capsule 510 can additionally include sensor elements for measuring pH, temperature and pressure. A suitable small charge coupled device camera system 524 is the 0.25″ color charge coupled device cameras of Sony Corporation of Japan. This single chip includes the charge-coupled device and the electronics for producing a video signal from the output of the charge coupled device. The charge-coupled device can either provide black and white signals or color signals. Because it is desired to view the walls of the digestive tract, the viewing window 522 typically is located on a side of the capsule 510. The optical system 526 includes a mirror 527 and a focusing lens 529. The mirror 527 is a dichroic mirror that transmits the light from the light source 520, which may be a light emitting diode, to the walls of the digestive tract via the viewing window 522. The mirror 527 deflects the light reflected from the digestive system towards the focusing lens 529. The focusing lens 529 focuses the light onto the charge coupled device camera system 524.

Referring to FIG. 19 in conjunction with FIG. 20 and FIG. 21 the dental video camera 610 also includes an adjustably focusing lens and charge coupled device camera system 620 that is disposed within the proximal portion 613 of the housing 611. The adjustably focusing lens and charge coupled device camera system 620 also includes a first sleeve 625 and a second sleeve 626. The first sleeve 625 has a longitudinal axis. The first sleeve 625 is axially aligned along the longitudinal axis and is disposed within the elongated cavity of the housing 611 adjacent to the fixed focusing lens system 620. The first sleeve 625 is able to rotate about the longitudinal axis and is restrained from moving laterally back and forth along the longitudinal axis. The second sleeve 626 is telescopically and slidably coupled to the first sleeve 625. The second sleeve 626 is able to move laterally back and forth along the longitudinal axis and is restrained from rotating about the longitudinal axis. The knob 615 bi-directionally drives the second sleeve 626 laterally to produce back and forth lateral movements along the longitudinal axis. A slide mechanism may bi-directionally drives the second sleeve 626 laterally to produce back and forth lateral movements along the longitudinal axis. The back and forth lateral movements of the second sleeve 626 generate clockwise and counterclockwise rotations, respectively, of the first sleeve 625. The adjustably focusing lens and charge coupled device camera system 620 also includes a first achromatic lens, which is disposed in a first lens carrier 627, and a second achromatic lens, which is disposed in a second lens carrier 628. The first lens carrier 627 with the first achromatic lens is disposed within and coupled to the first sleeve 625. The second lens carrier 628 with the second achromatic lens is disposed within the first sleeve 625 and is fixedly coupled to the first sleeve 625. The adjustably focusing lens and charge coupled device camera system 620 further includes a spring 629. The spring 629 resiliently couples the charge coupled device camera 621 to the elongated cavity of the housing 611. The second sleeve 626 engages the charge coupled device camera 621 and laterally moves the charge coupled device camera 621 back and forth. The back and forth lateral movements of the second sleeve 626 changes the position of the charge coupled device camera 621 with respect to the first and second achromatic lenses thereby changing the field of focus. The adjustably focusing lens and charge coupled device camera system 620 provides a focusing adjustment between a near field of focus and a far field of focus. The dental video camera 610 also includes an adjustable iris 630 that is optically and mechanically coupled to the adjustably focusing lens system 620. The adjustable iris 630 is adjusted between a nearly closed opening and a wide-open opening in response to the focusing adjustment between the near field of focus and the far field of focus. When the knob 615 is in the neutral position the opening of the adjustable iris 630 is between nearly closed and wide-open.

Referring to FIG. 20 in conjunction with FIG. 21 when the knob 615 has been rotated counter-clockwise forty-five degrees from the neutral position the opening of the adjustable iris 630 is wide-open.

From the foregoing it can be seen that a dental video camera has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A dental video camera comprising:
a. a housing having an elongated cavity having a proximal end and a distal end;
b. a fixed lens system disposed within said elongated cavity;
c. an adjustably focusing lens and CCD camera system disposed within said elongated cavity;
d. a mechanism coupled to said housing whereby said mechanism bi-directionally drive said adjustably focusing lens and CCD camera system disposed to produce back and forth lateral movements; and
e. a plurality of lamps mechanically coupled to said housing at said distal end.

2. A dental video camera comprising:
a. a housing having an elongated cavity having a proximal end and a distal end;
b. an fixed lens system disposed within said elongated cavity;
c. a CCD camera system disposed within said elongated cavity;
d. a mechanism coupled to said housing whereby said mechanism laterally moves said CCD camera system back and forth in order to change the position of said CCD camera system with respect to said fixed lens system thereby changing the field of focus; and
e. a plurality of lamps mechanically coupled to said housing at said distal end.
